(19) United States
(12) Patent Application Publication
(10) Pub. No.: US 2019/0242996 A1
(43) Pub. Date: Aug. 8, 2019

(54) METHOD, SYSTEM, AND APPARATUS FOR MEASURING DISPLACEMENT

(71) Applicant: Mark Allen Pfluger, El Paso, TX (US)

(72) Inventor: Mark Allen Pfluger, El Paso, TX (US)

(21) Appl. No.: 15/887,591

(22) Filed: Feb. 2, 2018

(51) Int. Cl. G01S 17/08; G01S 17/89; G01S 17/48; G01S 17/58; G01B 11/14

(52) U.S. Cl. CPC G01S 17/08; G01S 17/89; G01B 11/14; G01S 17/58; G01S 17/48

(57) ABSTRACT

An apparatus is disclosed. The apparatus has a measuring body and a first laser device supported on the measuring body and configured to emit a first laser. The apparatus also has a second laser device supported on the measuring body, the second laser device configured to emit a second laser that intersects with the first laser at a reference distance from the measuring body. The apparatus further has a laser measuring device supported on the measuring body. The laser measuring device is configured to detect a first reflection of the first laser on the measuring body, the first reflection of the first laser reflecting from a reflection distance from the measuring body. The laser measuring device is configured to detect a second reflection of the second laser on the measuring body, the second reflection of the second laser reflecting from the reflection distance.

### TECHNICAL FIELD

The present disclosure is directed to a method, system, and apparatus for measuring displacement, and more particularly, to a method, system, and apparatus for measuring displacement of an object or body.

### BACKGROUND OF THE DISCLOSURE

Laser technology is often used in determining a distance from a point of reference to an object. For example, laser range-finding is often used in applications such as military reconnaissance and targeting activities. For example, a single laser beam is typically used to determine distance to a given object via use of a timed laser pulse.

Although the above conventional uses of laser technology may adequately measure linear distance, such conventional methods are unable to determine a rate of displacement of an object. Also, such conventional methods are subject to error based on various factors, e.g., error caused by the influence of the Doppler Effect.

The exemplary disclosed method, system, and apparatus of the present disclosure is directed to overcoming one or more of the shortcomings set forth above and/or other deficiencies in existing technology.

### SUMMARY OF THE INVENTION

In one aspect, the present invention is directed to an apparatus. The apparatus includes a measuring body and a first laser device supported on the measuring body and configured to emit a first laser. The apparatus also includes a second laser device supported on the measuring body, the second laser device configured to emit a second laser that intersects with the first laser at a reference distance from the measuring body. The apparatus further includes a laser measuring device supported on the measuring body. The laser measuring device is configured to detect a first reflection of the first laser on the measuring body, the first reflection of the first laser reflecting from a reflection distance from the measuring body. The laser measuring device is configured to detect a second reflection of the second laser on the measuring body, the second reflection of the second laser reflecting from the reflection distance. The first and second reflections are configured to converge when the reference distance and the reflection distance converge.

In another aspect, the present invention is directed to a method. The method includes providing a measuring body, emitting a first laser from the measuring body, and emitting a second laser from the measuring body, the second laser intersecting with the first laser at a reference distance from the measuring body. The method also includes detecting a first reflection of the first laser on the measuring body, the first reflection of the first laser reflecting from a reflection distance from the measuring body. The method further includes detecting a second reflection of the second laser on the measuring body, the second reflection of the second laser reflecting from the reflection distance. The method additionally includes moving the first and second reflections toward each other based on moving the reference distance and the reflection distance toward each other.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1A is a schematic illustration of an exemplary system, in accordance with at least some exemplary embodiments of the present disclosure;

FIG. 1B is a schematic illustration of an exemplary user interface, in accordance with at least some exemplary embodiments of the present disclosure;

FIG. 2A is a schematic illustration of an exemplary system, in accordance with at least some exemplary embodiments of the present disclosure;

FIG. 2B is a schematic illustration of an exemplary user interface, in accordance with at least some exemplary embodiments of the present disclosure;

FIG. 3A is a schematic illustration of an exemplary system, in accordance with at least some exemplary embodiments of the present disclosure;

FIG. 3B is a schematic illustration of an exemplary user interface, in accordance with at least some exemplary embodiments of the present disclosure;

FIG. 4A is a schematic illustration of an exemplary system, in accordance with at least some exemplary embodiments of the present disclosure;

FIG. 4B is a schematic illustration of an exemplary user interface, in accordance with at least some exemplary embodiments of the present disclosure;

FIG. 5A is a schematic illustration of an exemplary system, in accordance with at least some exemplary embodiments of the present disclosure;

FIG. 5B is a schematic illustration of an exemplary user interface, in accordance with at least some exemplary embodiments of the present disclosure;

FIG. 6 is a schematic illustration of an exemplary system, in accordance with at least some exemplary embodiments of the present disclosure;

FIG. 7 is a flowchart illustrating an exemplary method, in accordance with at least some exemplary embodiments of the present disclosure;

FIG. 8 is a schematic illustration of an exemplary computing device, in accordance with at least some exemplary embodiments of the present disclosure; and

FIG. 9 is a schematic illustration of an exemplary network, in accordance with at least some exemplary embodiments of the present disclosure.

### DETAILED DESCRIPTION AND INDUSTRIAL APPLICABILITY

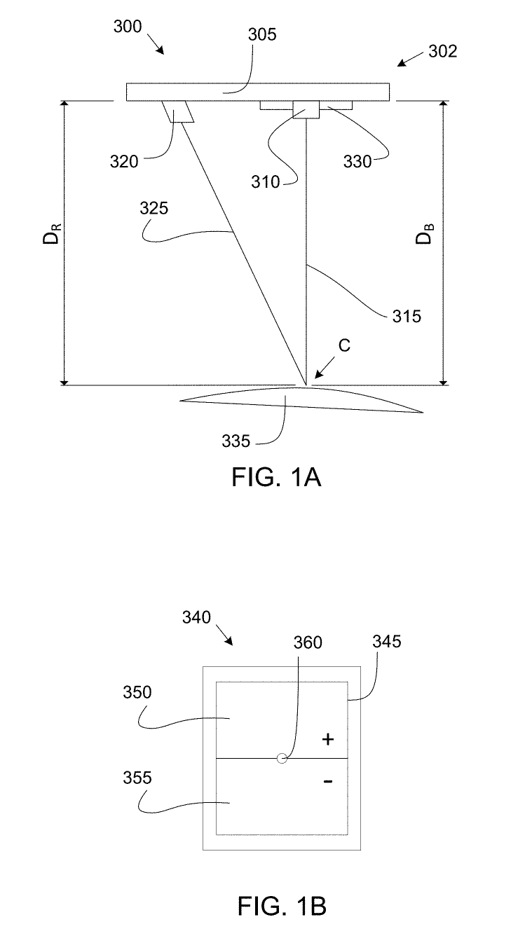

The exemplary disclosed method, system, and apparatus may be any suitable system for determining displacement of an object. For example, the exemplary disclosed system may be a laser intersection distance measurement and displacement measurement system as disclosed for example herein. For example, FIG. 1A illustrates an exemplary system 300 for determining displacement. System 300 may include a measuring assembly 302 for measuring data associated with an object.

Measuring assembly 302 may include a measuring body 305 on which a laser device 310 configured to emit a laser 315 and a laser device 320 configured to emit a laser 325 may be supported (e.g., attached or mounted by any suitable technique). Measuring assembly 302 may also include a laser measuring device 330 that may be supported (e.g., attached or mounted by any suitable technique) by measuring body 305. Measuring assembly 302 may include any suitable number of laser devices 310 and/or laser devices 320 and any suitable number of laser measuring devices 330 (e.g., may include an array of a plurality of exemplary laser devices and one or more exemplary measuring devices).

Measuring body 305 may be any suitable assembly for supporting (e.g., attaching or mounting by any suitable technique) laser device 310, laser device 320, and/or laser measuring device 330 as disclosed for example herein. For example, measuring body 305 may be a vehicle or a portion of a vehicle such as, e.g., a fixed wing or rotary wing aircraft (e.g., or a wing, fuselage, or other suitable component or assembly of an aircraft), a waterborne vessel (e.g., a maritime or naval vessel or a portion of a vessel, and/or any suitable vessel that may float on and/or submerge and move through a body of water such as an ocean, a lake, or a river), a ground vehicle or portion of a ground vehicle, any other suitable type of vehicle (e.g., a hot air balloon or a dirigible airship) and/or a building or other structure or a portion of a structure. For example, measuring body 305 may be an aircraft, and a first laser device (e.g., laser device 310) and a second laser device (e.g., laser device 320) may be mounted on a fuselage or a wing of the aircraft. It is also contemplated that measuring body may comprise a plurality of vehicles, structures, and/or other objects on which laser device 310, laser device 320, and/or laser measuring device 330 may be supported (e.g., attached or mounted by any suitable technique). For example, measuring body 305 may be any suitable body or object having sufficient baseline (e.g., length, width, or other dimension) for creating an angle between laser device 310 and laser device 320 as disclosed for example herein.

Laser device 310 may be any suitable device for emitting a laser. For example, laser device 310 may be a continuous wave laser, a pulsed laser (e.g., a long pulse laser or a short pulse laser), or a quasi-continuous mode laser. For example, laser device 310 may be a CO2, Argon laser, KTP laser, or Q-switched nanosecond laser. For example, laser device 310 may be a gas laser such as, e.g., a krypton laser, a carbon monoxide laser, a nitrogen laser, an excimer laser, a xenon ion laser, or a helium-neon laser. Also for example, laser device 310 may be a solid-state laser such as, e.g., a Nd:YAG laser, a Neodymium doped laser, an Er:YAG laser, an Ytterbium doped laser, or a Holmium YAG laser. Further for example, laser device 310 may be a chemical laser such as, e.g., a deuterium fluoride laser, or a hydrogen fluoride laser. Additionally for example, laser device 310 may be a semiconductor laser such as, e.g., a semiconductor laser diode, a GaN laser, a quantum cascade laser, or a hybrid silicon laser. Also for example, laser device 310 may be a metal-vapor laser such as, e.g., a manganese vapor laser, a helium-cadmium laser, a helium, -selenium laser, a helium-mercury laser, or a helium-silver laser. Further for example, laser 310 may be a gas dynamic laser, a Raman laser, or a free electron laser.

Laser device 310 may for example be supported (e.g., attached or mounted by any suitable technique) on measuring body 305 by any suitable technique. For example, laser device 310 may be mounted on a movable assembly that allows laser device 310 to maintain a stationary position and also to selectively rotate or displace to change an orientation of laser device 310. For example, laser device 310 may include a power assembly, motor assembly, and/or any other suitable actuation assembly to rotate, deflect, and/or change an orientation of laser device 310 as desired. For example, laser device 310 may include an electrical power assembly, a hydraulic power assembly, a pneumatic power assembly, a magnetic-powered assembly, and/or any other suitable assembly for driving a movement, rotation, and/or displacement of laser device 310. For example, laser device 310 may be moved, rotated, and/or actuated to emit laser 315 in any desired direction. For example, laser device 310 may be moved, rotated, and/or displaced to emit laser 315 in a direction normal (e.g., at a 90° angle to a length and/or width direction of measuring body 305) to a surface of measuring body 305 as illustrated in FIG. 1A. Laser device 310 may also be moved, rotated, and/or displaced to emit laser 315 in a direction that is at an angle to a direction normal to measuring body 305 (e.g., at any suitable angle such as, e.g., between about 0° and about 5°, between about 0° and about 10°, between about 0° and about 15°, between about 0° and about 20°, between about 0° and about 30°, between about 30° and about 45°, between about 30° and about 60°, between about 45° and about 70°, between about 60° and about 90°, and/or any other suitable angle from a direction that is substantially perpendicular to a surface of measuring body 305).

Laser device 320 may be substantially similar to laser device 310. For example, laser device 320 may emit laser 325 in any suitable direction such as, e.g., substantially perpendicular or normal to a surface of measuring body 305 and/or at any suitable angle from a direction that is substantially perpendicular or normal to a surface of measuring body 305. Laser device 320 may be spaced at any suitable distance (e.g., spaced at any suitable interval) from laser device 310. For example, laser device 320 may be spaced any suitable distance from laser device 310 in order to create an angle between lasers 315 and 325. For example depending on an application of system 300, laser devices 310 and 320 may be spaced from each other at a distance of between about ¼ inch and about 2 inches, between about 1 inch and about 12 inches, between about 0.5 feet and about 2 feet, between about 1 foot and about 6 feet, between about 5 feet and about 15 feet, between about 10 feet and about 50 feet, between about 20 feet and about 100 feet, between about 50 feet and about 200 feet, between about 100 feet and about 500 feet, between about 200 feet and about 1000 feet, and/or between about 500 feet and about 1500 feet. It is also contemplated that laser devices 310 and 320 may be spaced apart by several miles. For example, laser devices 310 and 320 may be spaced apart from each other at a relatively close distance when measuring body 305 is a piece of laboratory equipment or other precision equipment. Also for example, laser devices 310 and 320 may be spaced apart from each other on a vehicle such as, e.g., on different portions of an aircraft wing, on different wings of an aircraft, on different portions of an aircraft fuselage, on different portions of a ground vehicle, on different portions of a naval or maritime vessel (or any other suitable type of waterborne vessel as disclosed herein), and/or on different portions of a building, bridge, or other structure (e.g., or any suitable combination thereof).

For example as illustrated in FIG. 1A, laser devices 310 and 320 may be spaced apart at any suitable distance as disclosed for example above to create an angle between respective lasers 315 and 325. For example, laser devices 310 and 320 may be disposed at any spacing from each other and at any configuration and/or angle that results in lasers 315 and 325 converging at a distance (e.g., point) that may be detected (e.g., as measured by laser measuring device 330 as disclosed below). For example, laser devices 310 and 320 may be disposed at a distance from each other on measuring body 305 and positioned so that respective lasers 315 and 325 converge (e.g., converge as measured by laser measuring device 330 as disclosed for example below) at a desired point C (e.g., convergence point) as illustrated in FIG. 1A. For example, point C may be an intersection of the exemplary lasers (e.g., an intersection of lasers 315 and 325).

For example, in order to facilitate an operation of laser measuring device 330 as disclosed below, laser devices 310 and 320 may have differing properties relative to each other in order to emit respective lasers 315 and 325 having differing properties. For example, lasers 315 and 325 may have different frequencies, coding, pulsing, and/or any other differing properties in order to differentiate lasers 315 and 325 from each other to enhance an operation of laser measuring device 330.

For example, laser device 310 and/or laser device 320 may be positioned (e.g., angled, moved, rotated, and/or actuated as disclosed for example above) so that respective lasers 315 and 325 converge at a desired point C (e.g., as measured by laser measuring device 330 as disclosed for example below). For example, point C may be disposed at a distance D_{R} (e.g., reference distance) from measuring body 305. For example, distance D_{R} may be a predetermined distance that may serve as a known, predetermined distance and/or point on which calculations and processes of system 300 may be based. Distance D_{R} may be based for example on a position, angle or orientation, and/or configuration of laser device 310 and/or laser device 320. Distance D_{R} may provide a useful benchmark (e.g., baseline data used in an operation of system 300 as disclosed below) and may be varied as desired. For example, distance D_{R} may be set based on criteria associated with measuring body 305 (e.g., vehicle criteria if measuring body 305 is an aircraft, waterborne vessel, ground vehicle, or other type of vehicle such as the exemplary vessels disclosed herein). For example, depending on a preference of a user and/or parameters and/or criteria based on ambient conditions, properties of system 300 and/or a measured object, distance D_{R} may be varied to optimize an operation of system 300. For example, depending on an application or purpose of use of system 300, the ambient environment in which system 300 is operating, and/or the properties of an object being measured, distance D_{R} may be adjusted as necessary to allow for a suitable operation of system 300. Distance D_{R} may for example be set to any suitable distance at which convergence point C may be detected by system 300 (e.g., as measured by laser measuring device 330 as disclosed below). Distance D_{R} may be for example any suitable distance such as, e.g., microscopic distances (e.g., between about 1 nanometer and about 1 micrometer, between about 100 nanometers and about 1 millimeter, and/or between about 1 micrometer and about 1 centimeter). Distance D_{R} may also be for example between about 1 millimeter and about 1 meter. Distance D_{R} may also be for example between about 1 meter and about 10 meters, between about 1 meter and about 100 meters, and/or between about 10 meters and about 1 kilometer. Distance D_{R} may also be between about 1 km and several kilometers (e.g., or miles or nautical miles). Distance D_{R} may also be a relatively large distance such as, for example, tens, hundreds, and/or thousands of miles or kilometers. For example, a user and/or system 300 may set distance D_{R} to any desired distance based on positioning (e.g., moving, rotating, and/or actuating) laser devices 310 and/or 320 to emit lasers 315 and 325 to converge at a desired point C at a desired distance D_{R} (e.g., as measured by laser measuring device 330 as disclosed below). For example, laser devices 310 and 320 may be configured manually by a user and/or automatically by system 300 as desired or suitable based on an operation of system 300 (e.g., based on a given use or application of system 300). For example, laser devices 310 and 320 may be configured (e.g., positioned, moved, actuated, and/or rotated) to a predetermined position based on trigonometric and/or triangulation calculations to provide a desired distance D_{R}.

For example, one of laser device 310 and laser device 320 may be maintained at an angle that is substantially perpendicular (e.g., normal) to a surface of measuring body 305 (e.g., and laser measuring device 330) and the other of laser device 310 and laser device 320 may be positioned at an angle (e.g., not parallel) to the other laser device so that lasers 315 and 325 may converge at a point that can be detected. For example, one of laser devices 310 and 320 may be maintained at an orientation to emit one of lasers 315 and 325 substantially perpendicularly or normal to a surface of measuring body 305 (e.g., and of laser measuring device 330), which may simplify calculations based on measurements of laser measuring device 330 (e.g., trigonometric calculations may be simplified by basing calculations on a right triangle configuration of convergence of lasers 315 and 325 as illustrated in FIG. 1A). Also for example, laser devices 310 and 320 may be positioned to emit both lasers 315 and 325 at an angle to the perpendicular (e.g., normal) of a surface of measuring body 305 (e.g., and of laser measuring device 330).

Measuring assembly 302 may be used to measure a distance, displacement, and/or other properties of a body 335. For example, body 335 may be located at a reflection distance D_{B} (e.g., body distance) from measuring body 305 (e.g., an object, body, or any other suitable form of matter that may be measured by system 300). Distance D_{B} may vary based on a location of body 335 relative to measuring body 305. Distance D_{B} may be any suitable distance such as, for example, similar to the exemplary ranges disclosed above regarding distance D_{R}. For example, body 335 may be any suitable body or object that may be measured by system 300 such as, e.g., a surface of the earth including terrain features such as water, hills, mountains, and/or valleys, a vehicle such as a ground vehicle, aircraft, and/or naval, maritime, or other type of waterborne vessel, and/or an object in space such as an asteroid or debris circling the earth. For example if measuring body 305 is a stationary or moving aircraft, vessel, or vehicle, body 335 may be a point on the earth's surface or another vehicle that may move relative to measuring body 305. For example, measuring body 305 may be an aircraft and the target body (e.g., body 335) may be an earth surface (e.g., a point on the surface of the earth). For example, body 335 may be a relatively large reflecting surface that is suitable for reflecting laser energy (e.g., has suitable reflectance characteristics for given wavelengths of lasers of system 300).

For example, a convergence of lasers 315 and 325 (e.g., as measured by laser measuring device 330 as disclosed for example below) at predetermined distance D_{R} may (e.g., under certain conditions) correspond to distance D_{B} (e.g., or a distance to point C) of body 335 to measuring body 305. For example as disclosed below, lasers 315 and 325 may converge (e.g., as measured by laser measuring device 330) when distance D_{R} is substantially equal to distance D_{B}. Also for example, distance D_{R} may be greater than distance D_{B}. Further for example, distance D_{R} may be less than distance D_{B}. If for example distance D_{R} is maintained at a constant distance by a user and/or system 300, distance D_{B} may vary from being larger than, smaller than, and/or substantially equal to distance D_{R} based on a movement of body 335 relative to measuring body 305.

Laser measuring device 330 may be any suitable device for detecting and/or measuring a reflection of a laser beam (e.g., a reflection of lasers 315 and/or 325). For example, laser measuring device 330 may include a single detector or an array of detectors that may detect reflections of lasers 315 and 325. For example, a reflection of lasers 315 and 325 may be detected by laser measuring device 330 as a magnitude and trajectory (e.g., direction) of laser energy reflected from a surface of body 335. For example, laser measuring device 330 may be a device that operates on a triangulation measurement principle. For example, laser measuring device 330 may include a collection lens configured to collect a reflection of a laser beam emitted from a predetermined position (e.g., of laser device 310 and/or 320) and reflected by a surface of a target (e.g., a surface of body 335). For example, laser measuring device 330 may include a camera (e.g., a camera having pixels for measuring laser energy, a linear array camera, a CMOS array, and/or any other suitable camera for measuring a reflected laser) configured to receive and measure reflected laser energy (e.g., from a laser beam that is collected and provided by a collection lens). Also for example, laser measuring device 330 may include components for measuring and/or determining properties of a reflected laser beam (e.g., reflections of lasers 315 and/or 325) such as photodiode components, phototransistor components, and/or light dependent resistor components. For example, laser measuring device 330 may include one or more laser detector assemblies that may determine an angular distance (e.g., an angular spread) between reflections of lasers 315 and 325 to a suitable level of precision and/or accuracy (e.g., to a minute, and/or a second of arc measurement) to determine a displacement of body 335 relative to distance D_{R}. For example, laser measuring device 330 may use apparent linear variations in diverging laser reflections of lasers 315 and 325 to determine if body 335 is converging or diverging from the laser reflections based on displacements of the measured reflections.

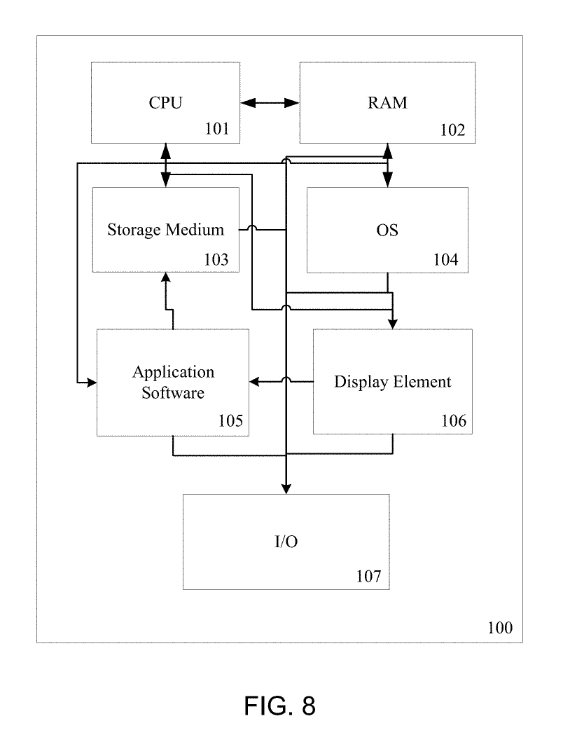

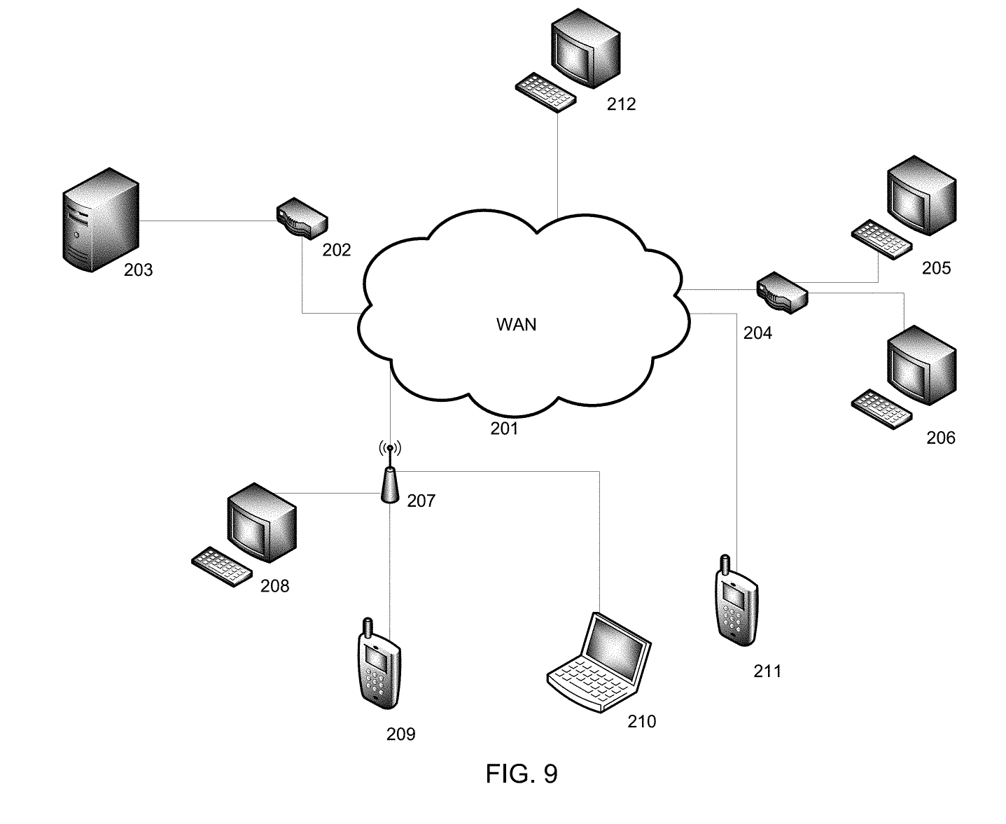

The output data from laser measuring device 330 may be provided in any suitable form such as, for example, raw numerical data, visual representation on a digital and/or analog user interface, and/or hard copy printout. For example, FIG. 1B illustrates an exemplary user interface 340 of laser measuring device 330. For example, user interface 340 may have any suitable components for entering input data and/or receiving output data (e.g., as disclosed below regarding FIGS. 8 and 9). For example, user interface 340 may have a display 345 (e.g., digital and/or analog display) having a first portion 350 and a second portion 355. For example, portions 350 and 355 may correspond to a displacement of an exemplary object (e.g., body 335) being measured by system 300. For example, portion 350 may correspond to a first displacement area or direction (e.g., a “+” area or direction) of body 335, and portion 355 may correspond to a second displacement area or direction (e.g., a “−” area or direction) of body 335. For example, such data may also be provided by any other suitable technique (e.g., any suitable technique for indicating a first and second displacement area or direction).

For example, when system 300 is in the exemplary configuration illustrated in FIG. 1A (e.g., when distance D_{R} is substantially equal to distance D_{B}, e.g., when a measured distance and/or point of body 335 is disposed at point of convergence point C of lasers 315 and 325), a marking 360 may be disposed (e.g., displayed) on user interface 340 at a line or point dividing portions 350 and 355. Marking 360 may for example indicate to a user (e.g., or such indication may be provided to system 300 and/or a user as data without user interface 340) that body 335 is disposed at distance D_{R} (e.g., that a reference distance D_{R} is substantially equal to a body distance D_{B} as illustrated in FIG. 1A). For example, marking 360 may include an indication of a reflection of laser 315 that is co-located (e.g., converged) with a reflection of laser 325. For example, when measuring reflections of lasers 315 and 325 of body 335, laser measuring device 330 may determine that a reflection of laser 315 has converged with (e.g., is measured at the same location as) laser 325. For example, laser measuring device 330 may determine that reflections of lasers 315 and 325 off of body 335 correspond to body 335 being at the location of predetermined reference distance D_{R} (e.g., that distance D_{R} substantially equals distance D_{B}). For example, based on the exemplary configuration of FIGS. 1A and 1B, data may be provided to a user and/or system 300 that body 335 has not displaced from reference distance D_{R} (e.g., that body 335 has not displaced relative to measuring body 305). For example in an exemplary embodiment in which measuring body 305 is a helicopter hovering above body 335 that is a ground surface (e.g., a measured point or location on the surface of the earth), the exemplary configuration of FIGS. 1A and 1B may indicate that measuring body 305 and body 335 have not moved relative to each other (e.g., that the exemplary helicopter is hovering or station keeping in place above the ground; e.g., that reference distance D_{R} has been attained by body 335). For example, user interface 340 may be configured to display a location of a first reflection (e.g., a first reflection of laser 315) relative to a location of the second reflection (e.g., a reflection of laser 325).

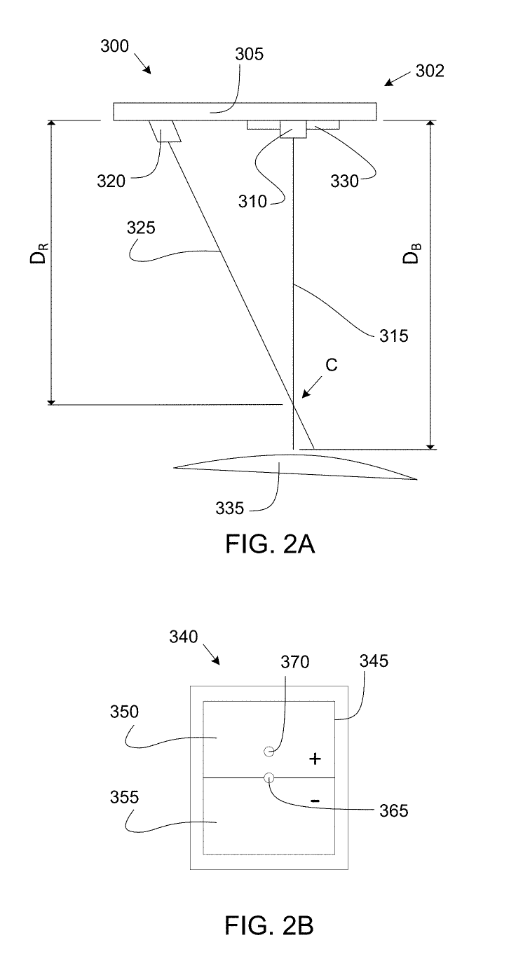

FIGS. 2A and 2B illustrate an additional exemplary configuration of system 300. As illustrated in FIG. 2A, body 335 may displace relative to measuring body 305 so that body distance D_{B} is greater than reference distance D_{R}. For example, body 335 may be disposed at a location that is further away from measuring body 305 than convergence point C. FIG. 2B illustrates exemplary output data of system 300 associated with the exemplary configuration of FIG. 2A. For example, because body distance D_{B} may be greater than reference distance D_{R}, laser measuring device 330 may provide system 300 with data indicating that a reflection of laser 325 (e.g., represented by marking 370 in FIG. 2B) has been determined to have moved relative to a reflection of laser 315 (e.g., represented by marking 365 in FIG. 2B). For example, user interface 340 may indicate that marking 370 is disposed by a determined amount in portion 350 (e.g., “+” portion), indicating that body 335 has displaced by an amount proportional to or otherwise mathematically related to an amount of movement by marking 370 in the “+” direction. Calculations may be made by system 300 by any suitable technique based on the above-described measurements of reflections of lasers 315 and 325 off of body 335 (e.g., as measured by laser measuring device 330). For example, a difference between reference distance D_{R} and reflection or body distance D_{B} may be proportional to a distance between a location of the first reflection (e.g., of laser 315) and a location of the second reflection (e.g., of laser 325) as measured by laser measuring device 330 and displayed on user interface 340.

For example, system 300 may utilize components (e.g., located at measuring body 305 and/or located remotely and communicating with other components of system 300 via a network) similar to those described below regarding FIGS. 8 and 9. For example, system 300 may include a module comprising computer-executable code stored in non-volatile memory and a processor that may make calculations based on measurements taken by and/or data provided by laser measuring device 330. For example (e.g., and as disclosed further below regarding FIGS. 8 and 9), system 300 may utilize software to conduct distance, velocity, and/or acceleration calculations based on measurements provided by laser measuring device 330. For example, an output of exemplary software may be customized to a specific application of system 300 (e.g., to terrain mapping for aircraft and/or station keeping for rotary aircraft). For example, exemplary software may provide a simple binary output (e.g., “+” or “−”) if desired output is data indicating whether or not distance D_{R} is greater than distance D_{B}. Also for example, exemplary software of system 300 may provide more detailed calculations and output if more refined data output is desired (e.g., based on a given purpose or application of system 300).

For example, system 300 may mathematically determine a linear distance between measuring body 305 and body 335 based on the changes in distance between measured reflections of lasers 315 and 325. For example, any changes in distance such as convergence (e.g., reflections of lasers 315 and 325 moving toward each other) or divergence (e.g., reflections of lasers 315 and 325 moving away from each other) may be determined by the changes in the direction of movement and/or the distance of movement of reflections of lasers 315 and 325 measured by laser measuring device 330. For example, a reflection of laser 315 may remain substantially fixed as measured by laser measuring device 330 (e.g., when laser device 310 is not moved and is maintained at a position so that laser 315 is emitted in a direction substantially perpendicular or normal to a surface of measuring body 305). Also for example, a reflection of laser 325 may be measured by laser measuring device 330 as moving closer to (e.g., converging) or further away (e.g., diverging) from a reflection of laser 315 due to changes in distance D_{B} between measuring body 305 and body 335. For example as illustrated in FIG. 2B (e.g., and in other exemplary embodiments below), a reflection (e.g., marking 370) of laser 325 measured in portion 350 (e.g., “+” portion) may indicate an increase of distance D_{B} between measuring body 305 and body 335 (e.g., may indicate that distance D_{B}>D_{R}). Also for example as illustrated in some exemplary embodiments herein, a reflection of laser 325 measured in portion 355 (e.g., “−” portion) may indicate a decrease of distance D_{B} between measuring body 305 and body 335 (e.g., may indicate that distance D_{B}<D_{R}).

Also for example, system 300 may make velocity, acceleration, and/or any other suitable calculations based on measurements taken by and/or data provided by laser measuring device 330. For example, a relative velocity and/or relative acceleration between measuring body 305 and body 335 may be calculated using displacement determinations based on measurements of reflections of lasers 315 and 325 from body 335 measured by laser measuring device 330. For example, a distance between reflections of lasers 315 and 325 measured by laser measuring device 330, a determination of which portion (e.g., portion 350 or portion 355) a reflection of laser 325 is measured as being disposed at, and/or a rate at which a reflection of laser 325 moves in relation to a reflection of laser 315 may provide data describing a direction, a magnitude and/or a rate of movement of member 335 relative to measuring body 305. For example, this data may be used by system 300 in calculating changes in distance, radial velocity, and/or radial acceleration between measuring body 305 and body 335. As disclosed in some exemplary embodiments herein, a reflection of laser 315 and/or a reflection of laser 325 may be measured as moving over portion 350 and/or portion 355.

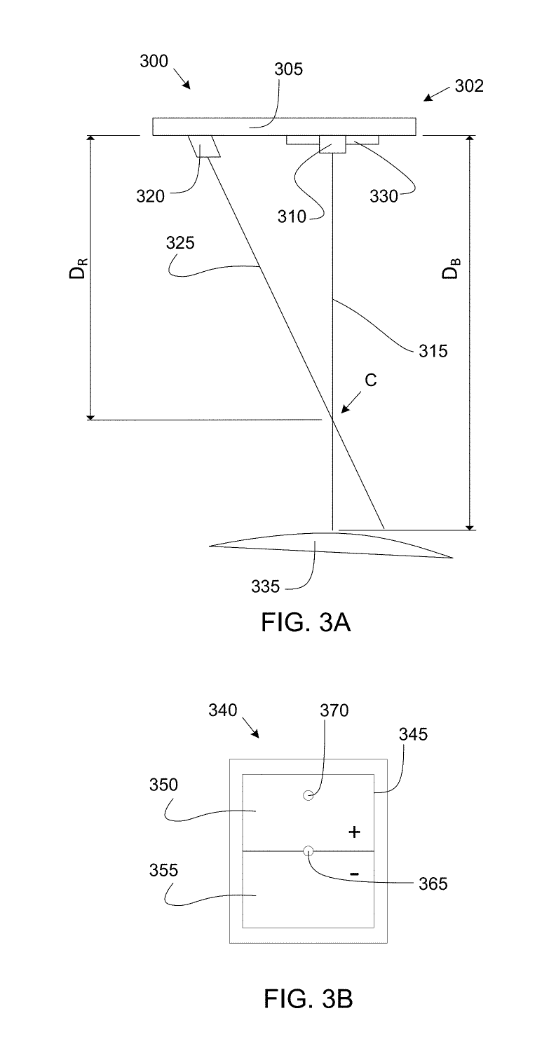

FIGS. 3A and 3B illustrate an additional exemplary configuration of system 300. As illustrated in FIG. 3A, body 335 may displace relative to measuring body 305 so that body distance D_{B} is greater than reference distance D_{R} (e.g., greater than the value of D_{B} illustrated in FIG. 2A). For example, body 335 may be disposed at a location that is farther away (relative to FIGS. 1A and 2A) from measuring body 305 than convergence point C. FIG. 3B illustrates exemplary output data of system 300 associated with the exemplary configuration of FIG. 3A. For example, because body distance D_{B} may be greater than reference distance D_{R} (e.g., greater than the amount illustrated in FIG. 2A), laser measuring device 330 may provide system 300 with data indicating that a reflection of laser 325 (e.g., represented by marking 370 in FIG. 3B) has been determined to have moved again relative to a reflection of laser 315 (e.g., represented by marking 365 in FIG. 3B). For example, user interface 340 may indicate that marking 370 is disposed by a determined amount in portion 350 (e.g., “+” portion), indicating that body 335 has displaced by an additional amount (e.g., relative to FIG. 2A) proportional to or otherwise mathematically related to an amount of movement by marking 370 in the “+” direction. Calculations may be made by system 300 by any suitable technique (e.g., similar to above) based on the above-described measurements of reflections of lasers 315 and 325 off of body 335 (e.g., as measured by laser measuring device 330).

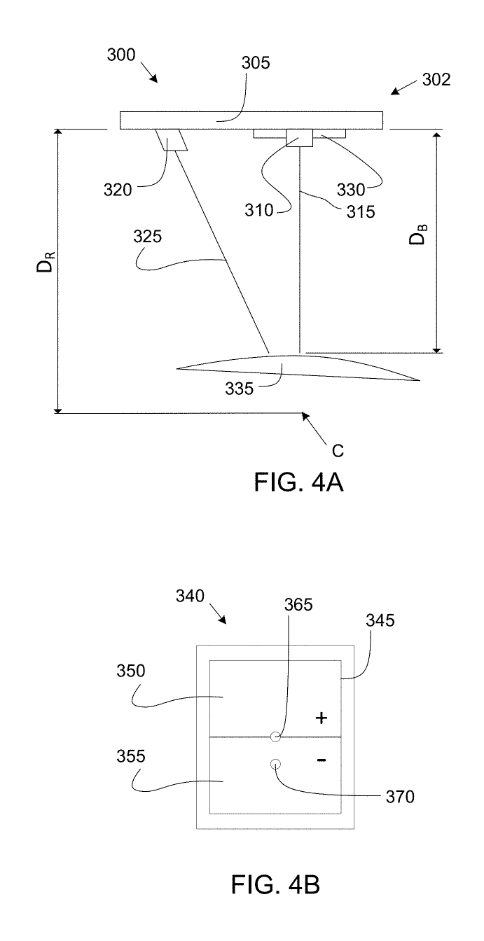

FIGS. 4A and 4B illustrate an additional exemplary configuration of system 300. As illustrated in FIG. 4A, body 335 may displace relative to measuring body 305 so that body distance D_{B} is less than reference distance D_{R}. For example, body 335 may be disposed at a location that is closer to measuring body 305 than convergence point C. FIG. 4B illustrates exemplary output data of system 300 associated with the exemplary configuration of FIG. 4A. For example, because body distance D_{B} may be less than reference distance D_{R}, laser measuring device 330 may provide system 300 with data indicating that a reflection of laser 325 (e.g., represented by marking 370 in FIG. 4B) has been determined to have moved relative to a reflection of laser 315 (e.g., represented by marking 365 in FIG. 4B). For example, user interface 340 may indicate that marking 370 is disposed by a determined amount in portion 355 (e.g., “−” portion), indicating that body 335 has displaced by an amount proportional to or otherwise mathematically related to an amount of movement by marking 370 in the “−” direction. Calculations may be made by system 300 by any suitable technique (e.g., similar to above) based on the above-described measurements of reflections of lasers 315 and 325 off of body 335 (e.g., as measured by laser measuring device 330).

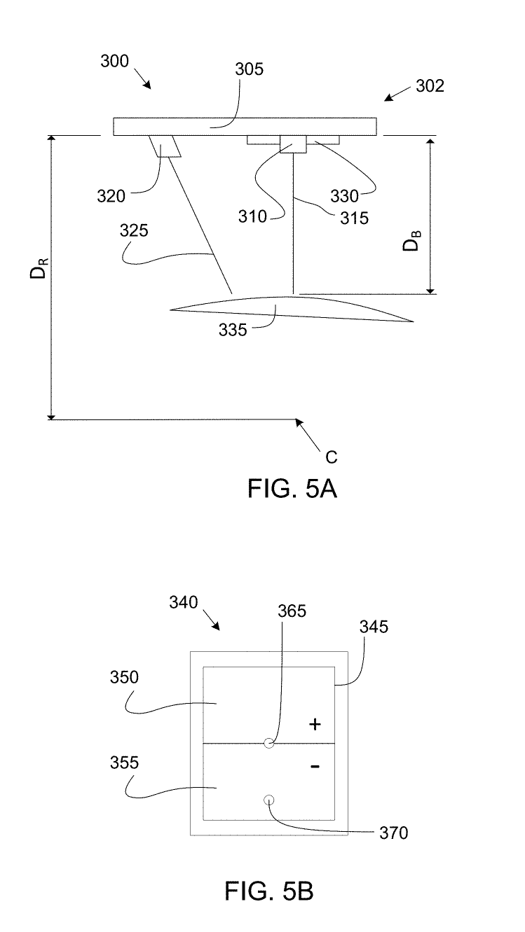

FIGS. 5A and 5B illustrate an additional exemplary configuration of system 300. As illustrated in FIG. 5A, body 335 may displace relative to measuring body 305 so that body distance D_{B} is less than reference distance D_{R} (e.g., less than the value of D_{B} illustrated in FIG. 4A). For example, body 335 may be disposed at a location that is closer to measuring body 305 than convergence point C (relative to FIG. 4A). FIG. 5B illustrates exemplary output data of system 300 associated with the exemplary configuration of FIG. 5A. For example, because body distance D_{B} may be less than reference distance D_{R} (e.g., less than the amount illustrated in FIG. 4A), laser measuring device 330 may provide system 300 with data indicating that a reflection of laser 325 (e.g., represented by marking 370 in FIG. 5B) has been determined to have moved relative to a reflection of laser 315 (e.g., represented by marking 365 in FIG. 5B). For example, user interface 340 may indicate that marking 370 is disposed by a determined amount in portion 355 (e.g., “−” portion), indicating that body 335 has displaced by an additional amount (e.g., relative to FIG. 4A) proportional to or otherwise mathematically related to an amount of movement by marking 370 in the “−” direction. Calculations may be made by system 300 by any suitable technique (e.g., similar to above) based on the above-described measurements of reflections of lasers 315 and 325 off of body 335 (e.g., as measured by laser measuring device 330).

In addition to the exemplary configurations disclosed above, marking 370 may be disposed at any other suitable position (e.g., in the “+” of “−” portions of user interface 340 based on a corresponding distance D_{B}). For example, reflections of lasers 315 and/or 325 (e.g., markings 365 and/or 370) may be disposed at any suitable distance from each other (e.g., as measured by laser measuring device 330) based on any suitable corresponding values of distances D_{R} and/or D_{B}.

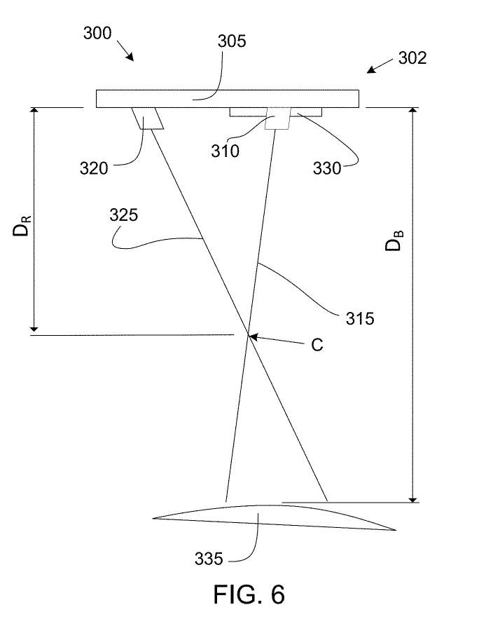

FIG. 6 illustrates an additional exemplary configuration of system 300. For example, both laser device 310 and laser device 320 may be disposed at an angle to a direction that is substantially perpendicular (e.g., normal) to a surface of measuring body 305 (e.g., and/or laser measuring device 330). A location of convergence point C and distance D_{R} may be located based on the corresponding emissions of lasers 315 and 325 (e.g., corresponding to the position, angle, and/or configuration of angled laser devices 310 and 320). For example, laser device 310 and/or laser device 320 may be angled relative to a direction that is substantially perpendicular (e.g., normal) to a surface of measuring body 305 to provide a desired convergence point C and distance D_{R} (e.g., angled laser devices 310 and 320 may provide additional flexibility (e.g., and/or scope or range) to a user in setting convergence point C and reference distance D_{R}).

For example, an exemplary system may include a measuring body (e.g., measuring body 305), a first laser device (e.g., laser device 310) supported on the exemplary measuring body and configured to emit a first laser (e.g., laser 315), and a second laser device (e.g., laser device 320) supported on the exemplary measuring body, the second laser device configured to emit a second laser (e.g., laser 325) that intersects with the first laser at a reference distance (e.g., distance D_{R}) from the measuring body. The exemplary system may also include a laser measuring device (e.g., laser measuring device 330) supported on the exemplary measuring body. The exemplary laser measuring device may be configured to detect a first reflection of the first laser (e.g., laser 315) on the exemplary measuring body, the first reflection of the first laser reflecting from a body or reflection distance (e.g., distance D_{B}) from the measuring body. The exemplary laser measuring device may be configured to detect a second reflection of the second laser (e.g., laser 325) on the measuring body, the second reflection of the second laser reflecting from the reflection distance. The first and second reflections are configured to converge (e.g., move toward each other, approach each other, and/or one or both reflections moving so that a distance between the reflections decreases) when the reference distance and the reflection distance converge (e.g., move toward each other, approach each other, and/or one or both of the reference distance and the reflection distance changing so that a difference between the reference distance and reflection distance decreases). Also for example, the exemplary system may include a processor and a displacement measurement module including computer-executable code stored in non-volatile memory (e.g., including components similar to the exemplary components described regarding FIGS. 8 and 9), wherein the processor and the displacement measurement module may be configured to determine a relative velocity or a relative acceleration between a target body disposed at the body or reflection distance (e.g., distance D_{B}) and measuring body 305 based on a rate of movement of at least one of the first reflection (e.g., of laser 315) and the second reflection (e.g., of laser 325) on measuring body 305 (e.g., as measured by laser measuring device 330).

The exemplary disclosed invention may provide a method, system, and apparatus for determining displacement, velocity, and acceleration of an object. The exemplary disclosed method, system, and apparatus may be used in any application that determines changes in distance, velocity, and/or acceleration between an observer and an observed object. For example, the exemplary disclosed method, system, and apparatus may be used in any application utilizing information for station keeping, obstacle avoidance, rate of closure (e.g., between two objects such as an observer and an observed object), and/or terrain following (e.g., traveling at a desired distance to terrain). For example, the exemplary disclosed method, system, and apparatus may be used in a variety of aeronautical, aerospace, and/or nautical applications and operations. For example, the exemplary disclosed method, system, and apparatus may be used in aircraft and/or waterborne vessel navigation and for obstacle detection and avoidance by vessels (e.g., or any suitable type of waterborne vessels as disclosed herein) and/or aircraft, delivery of guided munitions, and/or station keeping by aircraft and/or naval vessels (e.g., station keeping for hovering rotary wing aircraft and/or station keeping by naval vessels traveling with other vessels in a fleet formation). The exemplary disclosed method, system, and apparatus may also be used in obstacle avoidance and navigation systems for any suitable type of vehicle, such as ground vehicles, hovercraft, fixed wing and rotary wing aircraft, and/or waterborne vessels (e.g., maritime vessels, and/or any suitable vessel that may float on and/or submerge and move through any suitable body of water such as, e.g., an ocean or a lake).

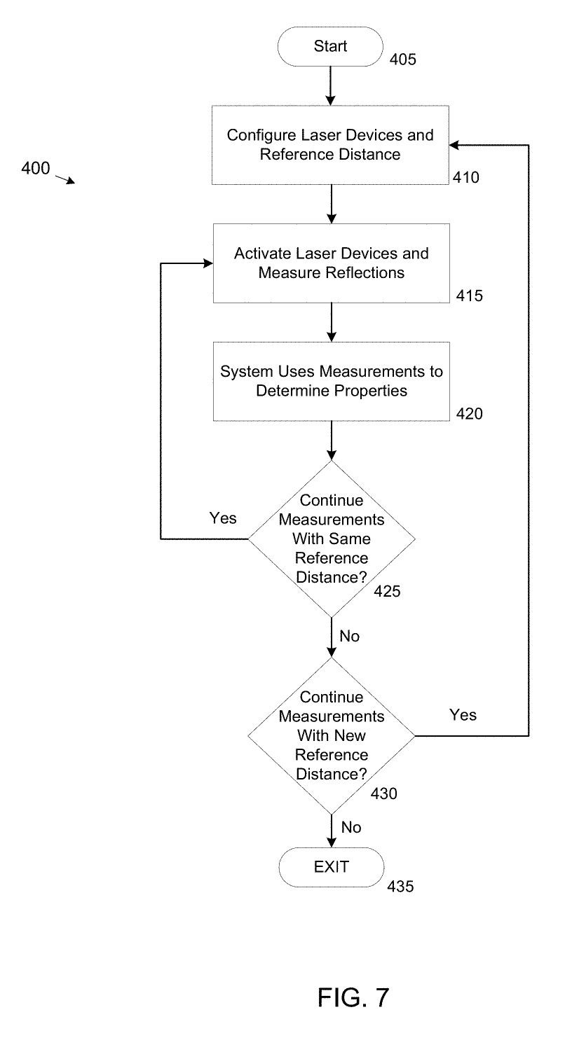

An exemplary method illustrating the operation of the exemplary system and apparatus will now be disclosed. For example, FIG. 7 illustrates an exemplary process 400 of the exemplary disclosed method, system, and apparatus.

For example, process 400 starts at step 405. At step 410 for example, a user may configure (e.g., and/or system 300 may automatically configure based on predetermined criteria and/or user input, e.g., via user interface 340) laser devices 310 and 320 as disclosed e.g. above to correspond to a desired reference distance D_{R} (e.g., as illustrated in FIG. 1A or 6). As disclosed for example above, laser devices 310 and 320 may be disposed in any suitable angle, position, location, and/or configuration to provide a desired convergence point C and reference distance D_{R}.

At step 415 for example, system 300 may activate laser devices 310 and 320 to respectively emit lasers 315 and 325. As disclosed above, laser measuring device 330 measures reflections of lasers 315 and 325 off of a surface of body 335. For example, system 300 may take measurements as disclosed above regarding, e.g., FIGS. 1B, 2B, 3B, 4B, and/or 5B (e.g., and/or based on an exemplary configuration of FIGS. 1A, 2A, 3A, 4A, 5A, and/or 6A).

At step 420 for example (e.g., and as disclosed above), system 300 may make velocity, acceleration, and/or any other suitable calculations based on measurements taken by and/or data provided by laser measuring device 330 at step 415. For example, a relative velocity and/or relative acceleration between measuring body 305 and body 335 may be calculated using displacement determinations based on measurements of reflections of lasers 315 and 325 from body 335 measured by laser measuring device 330 at step 415. System 300 may make calculations for example via components and processes disclosed above and/or components and processes disclosed below regarding FIGS. 8 and 9.

At step 425 for example, a user (and/or system 300 based on predetermined algorithms and/or user input entered for example via user interface 340) determines if system 300 will continue process 400 with the same reference distance D_{R} as determined for example at step 410. If process 400 is to be continued with the same reference distance D_{R}, the system returns to step 415 and repeats steps 415 and 420. If process 400 is not to be continued with the same reference distance D_{R}, (e.g., as determined at step 410), process 400 continues to step 430.

At step 430 for example, a user (and/or system 300 based on predetermined algorithms and/or user input entered for example via user interface 340) determines if system 300 will continue process 400 with a new reference distance D_{R} (e.g., a distance D_{R} that is different from the one previously set at step 410). If process 400 is to be continued with a new (e.g., changed or revised) reference distance D_{R}, the system returns to step 410 and calculates a new distance D_{R} as disclosed above regarding step 410. System 300 then repeats steps 415 and 420 using the new reference distance D_{R}. A user and/or system 300 then determines whether measurements will continue using the same or a new reference distance D_{R} at steps 425 and 430 respectively, and process 400 may continue (e.g., iteratively repeating steps 415 and 420 and/or steps 415, 420, and 425) as disclosed above.

If for example at step 430 a user (and/or system 300 based on predetermined algorithms and/or user input entered for example via user interface 340) determines that system 300 will not continue process 400 with a new reference distance D_{R}, then system 300 exits process 400 at step 435.

For example, the exemplary method may include providing a measuring body (e.g., measuring body 305), emitting a first laser (e.g., laser 315) from the exemplary measuring body, and emitting a second laser (e.g., laser 325) from the exemplary measuring body, the second laser intersecting with the first laser at reference distance D_{R} from the measuring body. The exemplary method may also include detecting a first reflection of the first laser on the measuring body, the first reflection of the first laser reflecting from a reflection distance (e.g., distance D_{B}) from the measuring body. The exemplary method may also include detecting a second reflection of the second laser on the measuring body, the second reflection of the second laser reflecting from the reflection distance. The exemplary method may further include moving the first and second reflections toward each other based on moving the reference distance and the reflection distance toward each other. The exemplary method may also include moving the first and second reflections away from each other based on moving the reference distance and the reflection distance away from each other. The exemplary method may additionally include displaying the first and second reflections on a user interface (e.g., user interface 340). For example, the exemplary method may include displaying the first and second reflections at the same location on the user interface when the reference distance is equal to the reflection distance (e.g., as illustrated in FIGS. 1A and 1B). For example, a first location of the first reflection on the measuring body may be the same as a second location of the second reflection on the measuring body when the reference distance is equal to the reflection distance (e.g., as illustrated in FIGS. 1A and 1B). Also for example, the exemplary method may include varying the reference distance based on varying an angle of emission of at least one of the first and second lasers, the angle of emission for example being an angle measured from a direction that is substantially perpendicular to a surface (e.g., normal to the surface) of the measuring body.

Also for example, the exemplary method may include detecting a first reflection of the first laser (e.g., laser 315) on the measuring body, the first reflection of the first laser reflecting from a target body (e.g., body 335). The exemplary method may also include detecting a second reflection of the second laser (e.g., laser 325) on the measuring body, the second reflection of the second laser reflecting from the target body. The exemplary method may also include determining a displacement of the target body from the reference distance based on measuring a distance between the first reflection and the second reflection (e.g., as measured by laser measuring device 330). Also for example, the exemplary method may include determining a relative velocity or a relative acceleration between the target body and the measuring body based on a rate of movement of at least one of the first reflection and the second reflection (e.g., as measured by laser measuring device 330). Also for example, a first location of the first reflection on the measuring body may be the same as a second location of the second reflection on the measuring body (e.g., as measured by laser measuring device 330 and for example as displayed by user interface 340 and/or as provided as data by system 300) when the target body is disposed at the reference distance from the measuring body.

Several advantages may be associated with the exemplary disclosed method, system, and apparatus. The exemplary disclosed method, system, and apparatus may for example provide a precise and accurate technique for measuring displacement, direction of movement, magnitude of velocity, and/or acceleration of an object. Also for example, the exemplary disclosed method, system, and apparatus may provide a precise and accurate technique for calculating changes in distance, changes in radial velocity, and/or changes in radial acceleration between a measuring body and an observed object. For example, the exemplary disclosed method, system, and apparatus may allow for accurate and precise distance and displacement measurement based on linear displacement laser reflections. Further for example, the exemplary disclosed method, system, and apparatus may instantaneously provide data describing a change in distance between an observer location and an observed object.

An illustrative representation of a computing device appropriate for use with embodiments of the system of the present disclosure is shown in FIG. 8. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 9, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 9, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 9, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. An apparatus, comprising:
a measuring body;
a first laser device supported on the measuring body and configured to emit a first laser;
a second laser device supported on the measuring body, the second laser device configured to emit a second laser that intersects with the first laser at a reference distance from the measuring body; and
a laser measuring device supported on the measuring body;
wherein the laser measuring device is configured to detect a first reflection of the first laser on the measuring body, the first reflection of the first laser reflecting from a reflection distance from the measuring body;
wherein the laser measuring device is configured to detect a second reflection of the second laser on the measuring body, the second reflection of the second laser reflecting from the reflection distance; and
wherein the first and second reflections are configured to converge when the reference distance and the reflection distance converge.

2. The apparatus of claim 1, wherein the measuring body is selected from the group consisting of a fixed wing aircraft, a rotary wing aircraft, and a waterborne vessel.

3. The apparatus of claim 1, wherein the second laser device is spaced at an interval from the first laser device.

4. The apparatus of claim 1, wherein at least one of the first laser device and the second laser device is configured to emit at least one of the first laser and the second laser in a direction that is substantially perpendicular to a surface of the measuring body.

5. The apparatus of claim 1, wherein at least one of the first laser device and the second laser device is configured to emit at least one of the first laser and the second laser at an angle to a direction that is substantially perpendicular to a surface of the measuring body.

6. The apparatus of claim 1, further comprising a user interface configured to display a location of the first reflection relative to a location of the second reflection.

7. The apparatus of claim 6, wherein a difference between the reference distance and the reflection distance is proportional to a distance between the location of the first reflection and the location of the second reflection.

8. The apparatus of claim 1, wherein the measuring body is an aircraft, and the first laser device and the second laser device are mounted on a fuselage or a wing of the aircraft.

9. The apparatus of claim 1, further comprising a processor and a displacement measurement module including computer-executable code stored in non-volatile memory, wherein the processor and the displacement measurement module are configured to determine a relative velocity or a relative acceleration between a target body disposed at the reflection distance and the measuring body based on a rate of movement of at least one of the first reflection and the second reflection.

10. A method, comprising:
providing a measuring body;
emitting a first laser from the measuring body;
emitting a second laser from the measuring body, the second laser intersecting with the first laser at a reference distance from the measuring body;
detecting a first reflection of the first laser on the measuring body, the first reflection of the first laser reflecting from a reflection distance from the measuring body;
detecting a second reflection of the second laser on the measuring body, the second reflection of the second laser reflecting from the reflection distance; and
moving the first and second reflections toward each other based on moving the reference distance and the reflection distance toward each other.

11. The method of claim 10, further comprising moving the first and second reflections away from each other based on moving the reference distance and the reflection distance away from each other.

12. The method of claim 10, further comprising displaying the first and second reflections on a user interface.

13. The method of claim 12, further comprising displaying the first and second reflections at the same location on the user interface when the reference distance is equal to the reflection distance.

14. The method of claim 10, wherein a first location of the first reflection on the measuring body is the same as a second location of the second reflection on the measuring body when the reference distance is equal to the reflection distance.

15. The method of claim 10, further comprising varying the reference distance based on varying an angle of emission of at least one of the first and second lasers, the angle of emission being an angle measured from a direction that is substantially perpendicular to a surface of the measuring body.

16. A method, comprising:
providing a measuring body;
emitting a first laser from the measuring body;
emitting a second laser from the measuring body, the second laser intersecting with the first laser at a reference distance from the measuring body;
detecting a first reflection of the first laser on the measuring body, the first reflection of the first laser reflecting from a target body;
detecting a second reflection of the second laser on the measuring body, the second reflection of the second laser reflecting from the target body; and
determining a displacement of the target body from the reference distance based on measuring a distance between the first reflection and the second reflection.

17. The method of claim 16, further comprising determining a relative velocity or a relative acceleration between the target body and the measuring body based on a rate of movement of at least one of the first reflection and the second reflection.

18. The method of claim 16, wherein a first location of the first reflection on the measuring body is the same as a second location of the second reflection on the measuring body when the target body is disposed at the reference distance from the measuring body.

19. The method of claim 16, wherein the measuring body is an aircraft and the target body is an earth surface.

20. The method of claim 16, further comprising varying the reference distance based on varying an angle of emission of at least one of the first and second lasers, the angle of emission being an angle measured from a direction that is substantially perpendicular to a surface of the measuring body.
